(19) United States
(12) Patent Application Publication
(10) Pub. No.: US 2025/0184070 A1
(43) Pub. Date: Jun. 5, 2025

(54) METHOD, DEVICE AND COMPUTER PROGRAM PRODUCT FOR WIRELESS COMMUNICATION

(71) Applicant: ZTE Corporation, Shenzhen (CN)

(72) Inventors: Xiaoying MA, Shenzhen (CN); Jun XU, Shenzhen (CN); Bo DAI, Shenzhen (CN); Mengzhu CHEN, Shenzhen (CN); Youjun HU, Shenzhen (CN); Hong TANG, Shenzhen (CN); Xuan MA, Shenzhen (CN)

(21) Appl. No.: 19/050,995

(22) Filed: Feb. 11, 2025

Related U.S. Application Data
(63) Continuation of application No. PCT/CN2022/111905, filed on Aug. 11, 2022.

(51) Int. Cl. H04L 5/00; H04W 52/02; H04W 72/231

(52) U.S. Cl. CPC H04L 5/005; H04L 5/0053; H04W 52/0206; H04W 72/231

(57) ABSTRACT

A wireless communication method is disclosed. The method comprises: receiving, by a wireless communication terminal from a wireless communication node, control signaling comprising channel state information reference signal, CSI-RS, configuration information; receiving, by the wireless communication terminal from the wireless communication node, first signaling comprising a CSI-RS configuration indication associated with a port number or a dropping indication; and performing, by the wireless communication terminal, at least one of a CSI-RS measurement or a transmission of a channel state information, CSI, measurement report to the wireless communication node based on at least one of the CSI-RS configuration information or the CSI-RS configuration indication in the first signaling.

### CROSS-REFERENCE TO RELATED APPLICATIONS

This application is a continuation of International Patent Application No. PCT/CN2022/111905, filed Aug. 11, 2022, the disclosure of which is incorporated herein by reference in its entirety.

### TECHNICAL FIELD

This document is directed generally to wireless communications, and in particular to 5th generation (5G) or 6th generation (6G) wireless communication.

### BACKGROUND

With the development of wireless communication technology, the transmission rate, throughput, reliability and other performance indices of wireless communication systems have been greatly improved by using high frequency bands, large bandwidths, multi-antennas and other technologies. Meanwhile, greenhouse gas emission caused by the 5G base stations and large power consumption have become an issue with the deployment of 5G. Therefore, network energy saving is important not only for a green communication system but also for a reduction of the operation expense.

This document relates to methods, systems, and devices for a CSI measurement and report.

### SUMMARY

One aspect of the present disclosure relates to a wireless communication method. In an embodiment, the wireless communication method includes: receiving, by a wireless communication terminal from a wireless communication node, control signaling comprising channel state information reference signal, CSI-RS, configuration information; receiving, by the wireless communication terminal from the wireless communication node, first signaling comprising a CSI-RS configuration indication associated with a port number or a dropping indication; and performing, by the wireless communication terminal, at least one of a CSI-RS measurement or a transmission of a channel state information, CSI, measurement report to the wireless communication node based on at least one of the CSI-RS configuration information or the CSI-RS configuration indication in the first signaling.

Another aspect of the present disclosure relates to a wireless communication method. In an embodiment, the wireless communication method includes: transmitting, by a wireless communication node to a wireless communication terminal, control signaling comprising channel state information reference signal, CSI-RS, configuration information; transmitting, by the wireless communication node to the wireless communication terminal, first signaling comprising a CSI-RS configuration indication associated with a port number or a dropping indication; and receiving, by the wireless communication node from the wireless communication terminal, a channel state information, CSI, measurement report to the wireless communication node based on at least one of the CSI-RS configuration information or the CSI-RS configuration indication in the first signaling.

Another aspect of the present disclosure relates to a wireless communication terminal. In an embodiment, the wireless communication terminal includes a communication unit and a processor. The processor is configured to: receive, from a wireless communication node, control signaling comprising channel state information reference signal, CSI-RS, configuration information; receive, from the wireless communication node, first signaling comprising a CSI-RS configuration indication associated with a port number or a dropping indication; and perform at least one of a CSI-RS measurement or a transmission of a channel state information, CSI, measurement report to the wireless communication node based on at least one of the CSI-RS configuration information or the CSI-RS configuration indication in the first signaling.

Another aspect of the present disclosure relates to a wireless communication node. In an embodiment, the wireless communication node includes a communication unit and a processor. The processor is configured to: transmit, to a wireless communication terminal, control signaling comprising channel state information reference signal, CSI-RS, configuration information; transmit, to the wireless communication terminal, first signaling comprising a CSI-RS configuration indication associated with a port number or a dropping indication; and receive, from the wireless communication terminal, a channel state information, CSI, measurement report to the wireless communication node based on at least one of the CSI-RS configuration information or the CSI-RS configuration indication in the first signaling.

Various embodiments may preferably implement the following features:

Preferably, the control signaling comprises at least one of Radio Resource Control, RRC, signaling or Medium Access Control Control Element, MAC CE, signaling.

Preferably, the control signaling comprises at least one of: the CSI-RS configuration information, a CSI measurement report configuration, one or more CSI measurement configurations, or a port number list comprising one or more port numbers or one or more port number sets.

Preferably, the one or more port numbers or one or more port number sets are associated with at least one: the CSI-RS configuration information, the CSI measurement report configuration, a code book configuration, a power control offset adjust value from a maximum port number, or a CSI-RS resource mapping.

Preferably, a CSI-RS resource mapping comprises at least one of: a time domain resource, a frequency domain resource, a CDM group, or a power control offset for a predefined port number, and wherein at least one of: a time domain resource, a frequency domain resource, a CDM group, or a power control offset for a first port number is determined according to the at least one of: the time domain resource, the frequency domain resource, the CDM group, or the power control offset for the predefined port number.

Preferably, CSI-RS resource mapping comprises at least one of a time domain resource, a frequency domain resource means CSI-RS resource mapping includes at least one of a time domain resource information, a frequency domain resource information used to determine the at least one of a time domain resource, a frequency domain resource. In some embodiments, comprising at least one of a time domain resource, a frequency domain resource means including at least one of a time domain resource information, a frequency domain resource information used to determine the at least one of a time domain resource, a frequency domain resource.

Preferably, the predefined port number is a maximum port number in the port number list or a port number set configured in the CSI-RS resource mapping, or the port number configured in the CSI-RS resource mapping.

Preferably, the predefined port number is a maximum port number, a time domain resource, a frequency domain resource, a CDM group, or a power control offset for a first port number is determined according to the at least one of: the time domain resource, the frequency domain resource, the CDM group, or the power control offset for the maximum port number, wherein:
the time domain resource and frequency domain resource for the first port number is the M items of the time domain resource and frequency domain resource for the maximum port number; or
the time domain resource and frequency domain resource for the first port number is the time domain resource and frequency domain resource of the M CDM groups for the maximum port number; or
the CDM group for the first port number is the first M CDM groups for the maximum port number;
and wherein, M is equal to a value of the first port number divided by a CDM type number.

Preferably, the CSI-RS configuration information comprises a CSI-RS resource set, and the CSI-RS resource set comprises one or more CSI-RS resources configured with different port numbers.

Preferably, the CSI-RS resources set is for at least one of: a channel measurement, an interference measurement.

Preferably, a CSI-RS resource comprises at least one of a time domain resource, a frequency domain resource, a CDM type, a density, a CDM group, or a power control offset.

Preferably, the CSI-RS resources have a hierarchical relationship therebetween.

Preferably, at least one of a first time and frequency domain resource, a first CDM group, or a first density for a first one of the CSI-RS resource corresponding to a first port number is a subset of at least one of a second time and frequency domain resource, a second CDM group, or a second density for a second one of the CSI-RS resource corresponding to a second port number within the CSI-RS resource set, and the first port number is less than the second port number.

Preferably, a first time and frequency domain resource for one of the CSI-RS resource corresponding to a maximum port number is a union set of time and frequency domain resources for all the CSI-RS resource within the CSI-RS resource set.

Preferably, a power control offset for a first one of the CSI-RS resource corresponding to a first port number is less than a power control offset for a second one of the CSI-RS resource corresponding to a second port number within the CSI-RS resource set, and the first port number is less than the second port number.

Preferably, the wireless communication terminal configures the CSI-RS configuration information separately for different port numbers, the CSI-RS resource configured in the CSI-RS configuration information are configured with a same port number, wherein the CSI-RS configuration information is a CSI-RS resource setting or a CSI resource configuration.

Preferably, a CSI-RS resource mapping is associate with a port number list configured with more than one port numbers or a port number set configured with more than one port numbers, the wireless communication terminal performs a CSI-RS measurement according to each valid port number in the port number list or the port number set.

Preferably, the CSI-RS configuration indication comprises at least one of: a maximum port number indication, a port number activation or de-activation indication, a maximum port indication, a port number indication, a port number set indication, a base station state indication, an aperiodic CSI-RS resource activation indication, an aperiodic CSI measurement report activation indication, a dropping indication, a CSI measurement configuration indication, a semi-persistent CSI-RS resource activation indication, or a CSI-RS resource indication.

Preferably, the first signaling comprises at least one of: common downlink control information, DCI, dedicate DCI, broadcast DCI, multicast DCI, an MAC CE, or a system information block, SIB.

Preferably, the first signaling comprises an indicating field for one or more user equipments, UEs.

Preferably, the indicating field comprises a bitmap or a codepoint, and at least one of a bitwidth or a position of the indicating field is determined according to at least one of high layer signaling or a predetermined value.

Preferably, the CSI-RS configuration indication in the common DCI, the dedicate DCI, the broadcast DCI, or the multicast DCI is for at least one of a semi-persistent CSI-RS resource or an aperiodic CSI-RS resource.

Preferably, the dedicate DCI comprises a field indicating a triggering or an activation of the CSI measurement report or a CSI-RS resource, and a port number for the CSI-RS resource corresponding to the CSI measurement report or a port number for the CSI-RS resource is implicitly indicated by the field.

Preferably, the MAC CE comprises at least one of: the CSI-RS configuration indication, a field indicating an activation or deactivation of a port number or a port number set, a serving cell identifier, ID, a bandwidth part, BWP, ID, or a port number list ID.

Preferably, the wireless communication terminal performs at least one of the following operations:
applying, validating or activating the CSI-RS configuration information after a time period relative to the reception of the first signaling;
dropping, the CSI report which is generated before the first signaling;
performing the CSI-RS measurement after a first time period relative to the reception of the first signaling;
performing the transmission of the CSI measurement report after a second time period relative to the reception of a valid CSI-RS; or
performing the transmission of the CSI measurement report after a second time period relative to the reception of the first signaling or a valid CSI-RS configuration.

Preferably, at least one of the time period, the first time period, or the second time period is associated with at least one of: a predefined value, a time domain behavior, a UE capability, a system frame number, SFN, a Subcarrier Spacing, SCS, an acknowledgement, ACK, a physical uplink shared channel, PUSCH, preparation processing time, a CSI computation time, a frequency range, FR, type, a bandwidth part, BWP, switching delay, a high layer signaling, or a physical downlink shared channel, PDSCH, processing time.

Preferably, at least one of the time period, the first time period, or the second time period is predetermined or associated with a time domain behavior of a CSI-RS resource or a time domain behavior of the CSI measurement report.

Preferably, during at least one of the time period, the first time period, or the second time period, the wireless communication terminal does not perform a CSI-RS measurement for a CSI-RS configuration not applied, validated, or activated after the time period.

Preferably, during at least one of the time period, the first time period, or the second time period, the wireless communication terminal does not transmit a CSI measurement report based on a CSI-RS configuration not activated after the time period or a CSI measurement report configuration not activated after the time period.

Preferably, the CSI-RS configuration and the CSI measurement report configuration are activated correspondingly.

Preferably, when the CSI-RS configuration indication indicates a port number that the wireless communication terminal is not configured with, the wireless communication terminal ignores the CSI-RS configuration indication or perform the transmission of the CSI measurement report based on a baseline CSI-RS configuration.

Preferably, the baseline CSI-RS configuration is associated with a predetermined port number or a maximum port number.

Preferably, the CSI-RS configuration indication is valid when the CSI-RS configuration indication is for at least one of an aperiodic CSI measurement report activation indication, a semi-persistent CSI-RS resource activation indication, or a periodic CSI-RS resource indication.

Preferably, the CSI-RS configuration indication is valid when the CSI-RS configuration indication is for a CSI-RS resource for at least one of: channel measurement, interference measurement, rate matching, or intra cell interference measurement.

Preferably, the CSI-RS configuration indication is valid when the CSI-RS configuration indication is for at least one of: an aperiodic CSI measurement report, a semi-persistent CSI measurement report, or a periodic CSI measurement report.

Preferably, the wireless communication terminal transmits at least one of the following to the wireless communication node: whether the wireless communication terminal supports a port number list indication, whether the wireless communication terminal supports to be configured with more than one port numbers in a CSI-RS resource, whether the wireless communication terminal supports a CSI-RS configuration indication by DCI, whether the wireless communication terminal supports a CSI-RS configuration indication by a MAC CE, whether the wireless communication terminal supports a CSI-RS configuration indication, whether the wireless communication terminal supports to be configured with different port numbers in a CSI-RS resource set used for a channel measurement, a maximum support number of a port number, or a number of ports number types able to be reported at the same time or same slot.

Preferably, the wireless communication terminal transmits at least one of the following to the wireless communication node: a preferred port number, a preferred port number list, a preferred maximum port number, a preference of falling back to a baseline CSI-RS configuration, a preference of switching to a power saving state, a preference of Transmission Configuration Indicator, TCI, state, a preference of beam indication.

Preferably, the first signaling is enabled when at least one of the following events occurs: Radio Resource Control, RRC, signaling is configured to enable the first signaling;
a CSI-RS resource associated with more than one port numbers is configured;
a CSI-RS resource set used for a channel measurement including a CSI-RS with different port numbers;
RRC signaling enabling more than one port number configured for a CSI-RS resource is enabled; or

RRC signaling enabling more than one port number configured within a CSI-RS resource set for a channel measurement is enabled.

Preferably, the first signaling is enabled comprises at least one of: the wireless communication node is able to transmit the first signaling to the wireless communication terminal; the wireless communication node is able to transmit the first signaling with CSI-RS configuration indication to the wireless communication terminal; the wireless communication terminal monitors the first signaling; or an indicating field indicating an activation or deactivation of one or more port numbers exists in the first signaling.

Preferably, performing the CSI-RS measurement or a transmission of the CSI measurement report to the wireless communication node comprises at least one of the following:
the wireless communication terminal does not measure CSI based on a de-activated CSI-RS configuration;
the wireless communication terminal does not transmit the CSI measurement report if the CSI measurement report is not associated with a valid or active CSI-RS configuration;
the wireless communication terminal does not expect to receive signaling to trigger a trigger state which is associated with an invalid or de-activated CSI-RS configuration; or
the wireless communication terminal does not expect to receive signaling to trigger a trigger state which is associated with an invalid or de-activated CSI measurement report configuration;
wherein, the valid, active, invalid, or de-activated CSI-RS configuration or CSI measurement report configuration is determined based on at least one of the CSI-RS configuration information or the CSI-RS configuration indication in the first signaling.

Preferably, the wireless communication terminal not transmitting the CSI measurement report includes the wireless communication terminal not transmitting the CSI report on the PUCCH or PUSCH of the CSI report configuration. Preferably, the wireless communication terminal not transmitting includes the wireless communication terminal not transmitting the CSI report generated according to a CSI report configuration.

Preferably, the wireless communication node receives at least one of the following from the wireless communication terminal: whether the wireless communication terminal supports a port number list indication, whether the wireless communication terminal supports to be configured with more than one port numbers in a CSI-RS resource, whether the wireless communication terminal supports a CSI-RS configuration indication by DCI, whether the wireless communication terminal supports a CSI-RS configuration indication by a MAC CE, whether the wireless communication terminal supports a CSI-RS configuration indication, whether the wireless communication terminal supports to be configured with different port numbers in a CSI-RS resource set used for a channel measurement, a maximum support number of a port number, or a number of ports number types able to be reported at the same time or same slot.

Preferably, the wireless communication node receives at least one of the following from the wireless communication terminal: a preferred port number, a preferred port number list, a preferred maximum port number, a preference of falling back to a baseline CSI-RS configuration, a preference of switching to a power saving state, a preference of Transmission Configuration Indicator, TCI, state, a preference of beam indication.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a CSI resource configuration according to an example.

FIG. 2 shows a CSI-RS resource configuration according to an embodiment.

FIG. 3 shows a table indicating CSI-RS configuration indication for multiple cells according to an embodiment.

FIG. 4 shows an example of a schematic diagram of a wireless terminal according to an embodiment of the present disclosure.

FIG. 5 shows an example of a schematic diagram of a wireless network node according to an embodiment of the present disclosure.

### DETAILED DESCRIPTION

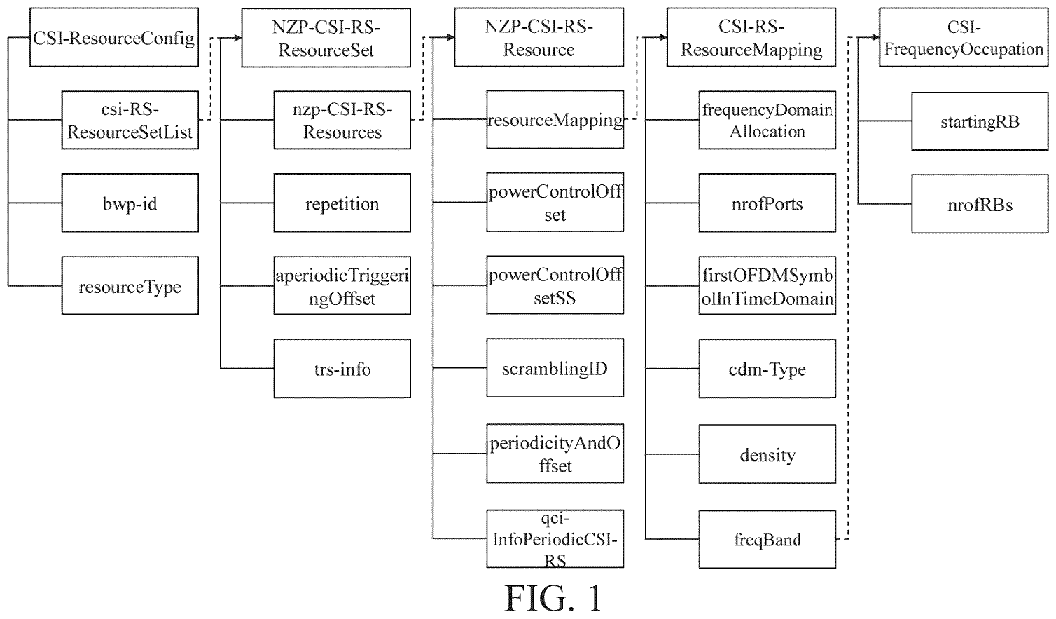

FIG. 1 shows a schematic diagram of a CSI resource configuration according to an example.

In a CSI (channel state information) measurement, a UE (user equipment) shall perform measurements based on CSI-RS (reference signal) and may report corresponding report to gNB.

CSI-RS: The CSI-RS may be used for time/frequency tracking, CSI computation, L1 (layer 1)-RSRP (reference signal received power) computation, L1-SINR (signal-to-noise and interference ratio) computation, mobility, and tracking during fast SCell (secondary cell) activation.

CSI: The time and frequency resources that can be used by the UE to report CSI are controlled by the gNB. CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP, L1-SINR or Capability [Set] Index.

CSI-RS resource: Each CSI Resource Setting CSI-ResourceConfig contains a configuration of a list of S≥1 CSI Resource Sets (given by higher layer parameter CSI-RS-ResourceSetList), where the list is comprised of references to either or both of NZP (non zero power) CSI-RS resource set(s) and SS/PBCH block set(s) or the list is comprised of references to CSI-IM (interference measurement) resource set(s). Each CSI Resource Setting is located in a DL (downlink) BWP (bandwidth part) identified by the higher layer parameter BWP-id, and all CSI Resource Settings linked to a CSI Report Setting have the same DL BWP. The time domain behavior of the CSI-RS resources within a CSI Resource Setting are indicated by the higher layer parameter resourceType and can be set to aperiodic, periodic, or semi-persistent.

CSI report: Each Reporting Setting CSI-ReportConfig is associated with a single downlink BWP (indicated by higher layer parameter BWP-Id) given in the associated CSI-ResourceConfig for channel measurement. The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, L1-SINR-related or Capability [Set] Index-related quantities to report.

For aperiodic CSI-RS report, RRC configures a CSI-AperiodicTriggerStateList, This List includes a list of associatedReportConfigInfoList, the associatedReportConfigInfoList indicates multiple CSI report configurations (also referred to as CSI measurement report configurations hereinafter). A DCI can trigger one entry in the CSI-AperiodicTriggerStageList. UE will measure CSI and report CSI according to the triggered entry. In some embodiments, CSI measurement report also referred to as CSI report or CSI.

For semi-persistent reporting on PUSCH, a set of trigger states are configured by higher layer CSI-SemiPersistentOnPUSCH-TriggerStateList, where the CSI request field in DCI scrambled with SP (semi-persistent)-CSI-RNTI activates one of the trigger states. A UE is not expected to receive a DCI scrambled with SP-CSI-RNTI activating one semi-persistent CSI report with the same CSI-ReportConfigId as in a semi-persistent CSI report which is activated by a previously received DCI scrambled with SP-CSI-RNTI. A semi-persistent CSI measurement report may include a semi-persistent on PUSCH CSI measurement report or a semi-persistent on PUCCH CSI measurement report.

For semi-persistent reporting on PUCCH, the PUCCH resource used for transmitting the CSI report are configured by reportConfigType. Semi-persistent reporting on PUCCH is activated by an activation command of MAC CE.

The number of ports of a CSI-RS is configured by nrofPorts in CSI-ResourceMapping, CSI-ResourceMapping is associated with an NZP-CSI-RS-Resource. The nrofPorts can be one of the following: p1, p2, p4, p8, p12, p16, p24, p32, in which p1 indicates one port, p2 indicates two ports, p8 indicates eight ports, and so on.

If the number of base station antenna changes, the number of CSI-RS port may also need to change. For example, a base station with 4 antennas can support 4 port CSI-RS, if the number of antennas decreased to 2 antennas, the base station cannot support 4 port CSI-RS. Therefore, UE performs CSI-RS measurement with different number of ports should be supported. And the number of CSI-RS port used may changes according to the change of number of base station antennas. In the prior art, most CSI-RS resource settings are configured by RRC (Radio Resource Control) signaling, and are a UE specific configuration. The RRC signaling overhead may be high if the gNB wants to change the number of CSI-RS ports for the UEs in the cell. Therefore, a new indication method of CSI-RS setting should be considered.

In some embodiment, to reduce the power consumption of a gNB, the number of antennas or antenna ports may be changed or reduced. In some embodiment, CSI measurement or CSI reporting may also changes corresponding to the change of number of antennas or antenna ports.

In some embodiments, the UE may perform one or more of the operations below, but does not limit thereto.

Receiving, a RRC signaling, the RRC signaling includes at least a CSI-RS configuration information.

Receiving, a first signaling, the first signaling includes a CSI-RS configuration indication.

Performing, measurements and CSI report according to the RRC signaling and/or the first signaling.

### Example 1: First Signaling Indicates a Maximum Port Number

In this example, the CSI-RS configuration information is a CSI-RS resource. The UE is configured with multiple CSI-RS resources. Each CSI-RS resource may be associated with a number of port information. A maximum port number list may be predefined or configured by a RRC signaling. The first signaling is a DCI. A field of X bits in the DCI is used to indicate one maximum port number in the maximum port number list. The bitwidth of the field is determined according to the number of maximum port number configured in the list. Each codepoint indicates one maximum port number. For example, RRC configured two maximum port number value {4,8}. bit ‘0’ means the maximum port number value is 4, bit ‘1’ means the maximum port number value is 8. If UE receives the DCI, the CSI-RS resource associated with the port number not larger than the maximum port number are valid/activated and the CSI-RS resource associated with a port number larger than the maximum port number are invalid/de-activated, the UE performs measurements and CSI report according to the valid/activated CSI-RS resource.

In some embodiments, the port number associated with the CSI-RS resource and/or other configurations described below may be explicitly indicated or implicitly indicated.

### Example 2: First Signaling Indicates a Port Number

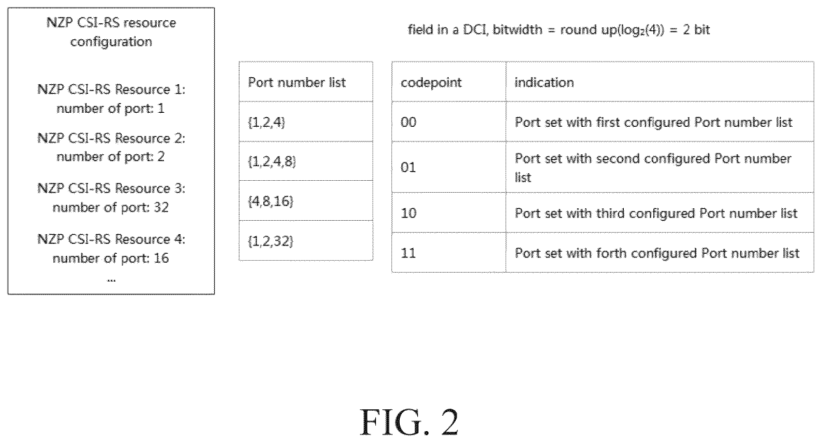

In this example, the CSI-RS configuration information is a CSI-RS resource. The UE is configured with multiple CSI-RS resource. Each CSI-RS resource may be associated with a number of port information. The first signaling is a DCI. A field of X bits in the DCI is used to indicate a port number list activation/de-activation. A port number list table may be predefined or configured by RRC signaling. The bitwidth of the field is determined according to the port number list table. The table includes multiple port number lists (or port number sets). Each bit indicates activation/de-activation of a set of port number. If UE receives the DCI, the CSI-RS resource associated with the active port number are valid/activated and the CSI-RS resource associated with other port number are invalid/de-activated, the UE performs measurements and CSI report according to the valid/activated CSI-RS resource (see FIG. 2). An active port number is the port number in the port number list (or port number set) indicated by the first signaling.

In this disclosure, active/valid/enable a port number means active/valid/enable a CSI-RS resource configured with the active/valid/enable port number.

The meaning of a CSI-RS configuration being valid/activated/enabled in some embodiments is described below, but not limited thereto.

In some embodiments, the CSI-RS configurations are valid/activated means the UE performs measurements according to the valid/activated CSI-RS configurations.

In some embodiments, the CSI-RS configurations are invalid/de-activated means the UE does not perform measurements according to the invalid/de-activated CSI-RS configurations.

In some embodiments, for periodic CSI-RS configuration, the CSI-RS configuration is valid/activated means at least one of the following:
The UE can measure on the periodic CSI-RS configuration;
Ignoring the indication; and/or
Activating the periodic CSI-RS configuration if the periodic CSI-RS resource is not activated. In other words, the UE can measure on the periodic CSI-RS configuration no matter whether it is activated before.

In some embodiments, for periodic CSI-RS configuration, the CSI-RS configuration is invalid/de-activated means at least one of the following:
The UE stops measuring on the periodic CSI-RS configuration;
Ignoring the indication; and/or
Releasing/de-activating the invalid/de-activated periodic CSI-RS configuration.

In some embodiments, for semi-persistent CSI-RS configuration, the CSI-RS configuration is valid/activated means at least one of the following:
The UE can measure on the semi-persistent CSI-RS configuration if the semi-persistent CSI-RS configuration has already been activated by a MAC CE. In the prior art, a semi-persistent CSI-RS resource can be activated by a MAC CE. In this embodiment, the valid/activated (or invalid/de-activated) indication carried by a first signaling is used for the semi-persistent CSI-RS resource which has already activated by the prior art method.
Ignoring the indication; and/or
The UE can measure on the semi-persistent CSI-RS configuration whether the semi-persistent CSI-RS configuration has been activated by MAC CE or not. In other words, an invalid/de-activated semi-persistent CSI-RS resource can be valid/activated. In this embodiment, the valid/activated (or invalid/de-activated) indication carried by a first signaling is used for all the semi-persistent CSI-RS resource or CSI report which is configured no matter whether or not it has been activated by the prior art method.

In some embodiments, for semi-persistent CSI-RS configuration, the CSI-RS configuration is invalid/de-activated means at least one of the following:
The UE does not measure on the invalid/de-activated semi-persistent CSI-RS configuration;
Ignoring the indication; and/or
Releasing/de-activating the invalid/de-activated semi-persistent CSI-RS configuration.

In some embodiments, for aperiodic CSI-RS configuration, the CSI-RS configuration is valid/activated means at least one of the following:
A aperiodic CSI-RS configuration can be triggered/activated by another DCI. In another words, a valid/activated aperiodic CSI-RS configuration can be selected to be used.
The UE can measure on the valid/activated aperiodic CSI-RS resource; and/or
Ignoring the indication.

In some embodiments, for aperiodic CSI-RS configuration, the CSI-RS configuration is invalid/de-activated means at least one of the following:
An invalid/de-activated aperiodic CSI-RS configuration cannot be triggered/activated by another DCI. In other words, an invalid/de-activated aperiodic CSI-RS configuration cannot be selected to be used; and/or
Ignoring the indication.

In some embodiments, the another DCI described above is a DCI with a CSI request field.

Some aspects of the present disclosure are described below, but the present disclosure is not limited thereto.

### Aspect 1: Configuration Information

This aspect relates to receiving a high layer signaling. The high layer signaling may be a MAC CE signaling or a RRC signaling. The high layer signaling includes at least one of the following: a CSI-RS configuration information, a CSI report configuration, one or more CSI measurement configurations (e.g., CSI-MeasConfig), and/or a port number list.

In some embodiments, a CSI-RS configuration information or a CSI report configuration is associated with a port number list. including one or more port numbers (e.g., numbers of port(s), or one or more port number sets (e.g., each set including one or more port numbers)).

In some embodiments, different CSI measurement configuration is configured using different high layer signaling. In another word, each CSI measurement configuration is configured using one signaling. For example, one CSI measurement configuration is using CSI-MeasConfig, the other CSI measurement configuration is using CSI-MeasConfig−1.

In some embodiments, one or more CSI-MeasConfig is configured in a list.

In some embodiments, the maximum port number configured in different CSI measurement configuration is different.

In some embodiments, the one or more port numbers or one or more port number sets are associated with at least one: the CSI-RS configuration information, the CSI measurement report configuration, a power control offset adjust value from a maximum port number, a code book configuration, or a CSI-RS resource mapping.

In some embodiments, the power control offset adjust value from a maximum port number (A) is used to determine a power control offset (e.g., powercontrolOffset) for a CSI-RS configuration with a port number in a port number list. For example, the power control offset is equal to divide A from the power control offset for a maximum port number.

In some embodiments, the code book configuration (e.g., CodebookConfig) is configured in the CSI measurement report configuration (e.g., CSI-ReportConfig). In some embodiments, the IE CodebookConfig is used to configure the codebooks of Type-I and Type-II.

In some embodiments, one CSI-RS configuration can be configured with more than one port numbers. The CSI-RS configuration information may include at least one of the following: a CSI-ResourceConfig, a NZP CSI-RS ResourceSet, a NZP CSI-RS Resource, a CSI-RS resourceMapping, a CSI-IM-ResourceSet, and/or a CSI-IM-Resource.

In some embodiments, the CDM type or density is assumed to be the same for all port numbers in one port number list (or port number set).

In some embodiments, the port number list in one CSI-RS configuration shares other configuration information. The other configuration information includes at least one of: density, frequencyDomainAllocation, firstOFDMSymbolInTimeDomain, firstOFDMSymbolInTimeDomain2, cdm-Type, freqBand.

In some embodiments, a CSI-RS configuration information is configured with a port number list (more than one port number) and the time and/or frequency resource is configured by RRC signaling for the CSI-RS configuration information. The entire time and/or frequency resource is used for the CSI-RS configuration with the maximum port number configured in the port number list, and the time and/or frequency resource for the CSI-RS configuration with the other port number can be derived from the time and frequency resource configured for the CSI-RS configuration with the maximum port number.

In some embodiments, the time and/or frequency resource for the other port number is the same as the first M time and/or frequency resource for the maximum port number (e.g., M=the other port number/CDM type number). The first M time and/or frequency resource for the maximum port number is the time and frequency resource for the first M CDM group for the maximum port number. In some embodiments, the time and/or frequency resource for the other port number is the same as the M time and/or frequency resource for the maximum port number (e.g., M=the other port number/CDM type number). In some embodiments, the M time and/or frequency resource for the maximum port number is the time and frequency resource for the M CDM group for the maximum port number. In some embodiments, M CDM group is configured by high layer signaling or predefined. In some embodiments, M time and/or frequency resource for the maximum port number is configured by high layer signaling or predefined. In some embodiments, M is configured by RRC signaling or predefined.

For example, a CSI-RS resource is configured with a port number list {24,12} and the following information: frequencyDomainAllocation, firstOFDMSymbolInTimeDomain, density, and cdm-Type. This information can be used to determine the CSI-RS time and frequency resource location and generate CSI-RS sequence according to a predefined information. UE can find a row in a predefined information (e.g., see the table below) to determine the CSI-RS time and frequency resource location, according to the configuration information.

| | Ports | Density | | | CDM group | | |
|---|---|---|---|---|---|---|---|
| Row | X | ρ | cdm-Type | (k̅, l̅) | index j | k′ | l′ |
| 13 | 24, 12 | 1 | fd-CDM2 | (k₀, l₀), (k₁, l₀), (k₂, l₀), | 0, 1, 2, 3, 4, 5, | 0, 1 | 0 |
| | | | | (k₀, l₀ + 1), (k₁, l₀ + 1), | 6, 7, 8, 9, 10, 11 | | |
| | | | | (k₂, l₀ + 1), (k₀, l₁), (k₁, l₁), | | | |
| | | | | (k₂, l₁), (k₀, l₁ + 1), | | | |
| | | | | (k₁, l₁ + 1), (k₂, l₁ + 1) | | | |

k₀, l₀, k₁, k₂, l₁ in the table above are obtained according to a RRC signaling (e.g., frequencyDomainAllocation and firstOFDMSymbolInTimeDomain) and used to indicates the time and frequency resource position.

The time and frequency resource for 24 ports are the time and frequency resource obtained by RRC signaling and is listed in the table. According to the table, the cdm-type is fd-CDM2, which means CDM type number is 2. The time and frequency resource for 12 ports are the first (12/2-6) time and frequency resource sets configured by RRC signaling. In another words, in the table above, (k₀, l₀), (k₁, l₀), (k₂, l₀), (k₀, l₀+1), (k₁, l₀+1), (k₂, l₀+1), (k₀, l₁), and CDM group index 0,1,2,3,4,5, may be use as the time and frequency resource for the case that the ports X is 12.

In some embodiments, time and frequency resource for a smaller port number in a port number list is a subset of the time and frequency resource configured by RRC signaling.

In some embodiments, the CDM group for a smaller port number in a port number list is a subset of the CDM group configured by RRC signaling.

In some embodiments, the powerControlOffset/powerControlOffsetSS configured by RRC signaling is used for the maximum port number in a port number list configured in the CSI-RS resource. The powerControlOffset/powerControlOffsetSS used for the other port number in the port number list configured in the CSI-RS resource is derived from the powerControlOffset/powerControlOffsetSS configured by RRC signaling. The powerControlOffset/powerControlOffsetSS used for the other port number configured in the CSI-RS resource is less than the powerControlOffset/powerControlOffsetSS configured by RRC signaling.

For example, the powerControlOffset/powerControlOffsetSSused for the other port number in a port number list configured in the CSI-RS resource reduces 10*log 10 (P1/P2) dB from the powerControlOffset/powerControlOffsetSS configured by RRC signaling. P1 is the maximum port number configured in the CSI-RS resource, P2 is the port number in the port number list configured for a CSI RS resource in the CSI-RS resource.

### Aspect 2: Configuration Information in Another Embodiment

In accordance with another embodiment of the present disclosure, the UE may receive a high layer signaling. The high layer signaling may be a MAC CE signaling or a RRC signaling. The high layer signaling includes at least one of the following: a CSI-RS configuration information, a CSI report configuration.

In some embodiments, CSI-RS resources within one set can be configured with different port numbers (nrofPorts). The CSI-RS resources may be used for a first kind usage. The first kind usage may include at least channel measurement, or interference measurement.

The usage may include Channel Measurement (CSI report configuration configured with resourcesForChannelMeasurement), interference measurement (CSI report configuration configured with csi-IM-ResourcesForInterference), rate matching (configured with ZP-CSI-RS-Resource) or intra cell interference measurement (CSI report configuration configured with nzp-CSI-RS-ResourcesForInterference).

In some embodiments, there is a hierarchical relationship among the CSI-RS resources configured within one set.

Hierarchical relationship means the time and/or frequency resource location of a CSI-RS resource configured with a smaller port number is a subset of the time and/or frequency resource location of a CSI-RS resource configured with a larger port number within one set.

In some embodiments, a first kind of configuration for one CSI-RS resource with a smaller port number configuration is a subset of or the same as another CSI-RS resource configured with a larger port number. In some embodiments, some first kind of configuration for one CSI-RS resource with a smaller port number configuration is a subset of another CSI-RS resource configured with a larger port number. And another first kind of configuration for the CSI-RS resource with a smaller port number configuration is a same as another CSI-RS resource configured with a larger port number.

The first kind of configuration includes at least one of following: the time and/or frequency resource, CDM type, density, CDM group index.

In some embodiments, No CDM is subset of {FD-CDM2, CDM4 (FD2, TB2), CDM8 (FD2, TD4)}, FD-CDM2 is subset of {CDM4 (FD2, TB2), CDM8 (FD2, TD4)}, CDM4 (FD2, TB2) is subset of CDM8 (FD2, TD4).

In some embodiments, a smaller density is a subset of a larger density. E.g., density 0.5 is a subset of a density 1.

In some embodiments, the time and/or frequency resource of a CSI-RS resource configured with a largest port number is the union set of the time and/or frequency resource of all CSI-RS resources within the set.

In some embodiments, the powerControlOffset/powerControlOffsetSS configured for a CSI RS resource configured with a smaller port number is associated with the powerControlOffset/powerControlOffsetSS configured for a CSI RS resource configured with a larger port number. In some embodiments, the powerControlOffset/powerControlOffsetSS configured for a CSI RS resource configured with a smaller port number is less than the powerControlOffset/powerControlOffsetSS configured for a CSI RS resource configured with a larger port number.

For example, the powerControlOffset/powerControlOffsetSS configured for a CSI RS resource configured with a smaller port number reduces 10*log₁₀(P1/P2) dB from the powerControlOffset/powerControlOffsetSS configured for a CSI RS resource configured with a larger port number, P1 is the port number configured for a CSI RS resource configured with a larger port number, P2 is the port number configured for a CSI RS resource configured with a smaller port number.

In some embodiments, the powerControlOffset/powerControlOffsetSS configured for a CSI RS resource configured with as smaller port number is associated with the powerControlOffset/powerControlOffsetSS configured for a CSI RS resource configured with a largest port number. In some embodiments, the powerControlOffset/powerControlOffsetSS configured for a CSI RS resource configured with a smaller port number is less than the powerControlOffset/powerControlOffsetSS configured for a CSI RS resource configured with a largest port number.

For example, the powerControlOffset/powerControlOffsetSS configured for a CSI RS resource configured with a smaller port number reduces 10*log₁₀(P1/P2) dB from the powerControlOffset/powerControlOffsetSS configured for a CSI RS resource configured with a largest port number, P1 is the port number configured for a CSI RS resource configured with a larger port number, P2 is the port number configured for a CSI RS resource configured with a smaller port number.

### Aspect 3: Configuration Information in Still Another Embodiment

In some embodiments, UE may be configured with multiple CSI-RS configuration information associated with different port number configurations.

In some embodiments, there is a hierarchical relationship among the CSI-RS configuration information.

Hierarchical relationship means the time and/or frequency resource location of a CSI-RS configuration information associated with a smaller port number is a subset of the time and/or frequency resource location of a CSI-RS configuration information associated with a larger port number.

In some embodiments, a first kind of configuration for one CSI-RS configuration information associated with a smaller port number configuration is a subset of or the same as another CSI-RS configuration information associated with a larger port number.

The first kind of configuration includes at least one of the following: the time and/or frequency resource, CDM type, density, CDM group index, powerControlOffset, or powerControlOffsetSS.

In some embodiments, No CDM is subset of {FD-CDM2, CDM4 (FD2, TB2), CDM8 (FD2, TD4)}, FD-CDM2 is subset of {CDM4 (FD2, TB2), CDM8 (FD2, TD4)}, CDM4 (FD2, TB2) is subset of CDM8 (FD2, TD4).

In some embodiments, a smaller density is a subset of a larger density. E.g., density 0.5 is a subset of a density 1.

In some embodiments, a powerControlOffset/powerControlOffsetSS configured for a first CSI RS configuration is less than the powerControlOffset/powerControlOffsetSS configured for a second CSI RS configuration and/or a powerControlOffset/powerControlOffsetSS configured for a first CSI RS configuration is a subset of a powerControlOffset/powerControlOffsetSS configured for a second CSI RS configuration.

For example, the powerControlOffset/powerControlOffsetSS configured for a first CSI RS configuration reduces 10*log₁₀(P1/P2) dB from the powerControlOffset/powerControlOffsetSS configured for a second CSI RS configuration, P1 is the port number configured for a first CSI RS configuration, P2 is the port number configured for a second CSI RS configuration. First CSI RS configuration is configured with a larger port number, second CSI RS configuration is configured with a smaller port number.

### Aspect 4: First Signaling

In some embodiments, the UE receives a first signaling, the first signaling includes a CSI-RS configuration indication. The CSI-RS configuration indication includes at least one of the following: a maximum port number indication, a port number activation/de-activation indication, a maximum port indication, a port number indication, a port number list indication, a base station state indication, an aperiodic CSI-RS resource activation indication, an aperiodic CSI report activation indication, a CSI measurement configuration indication, a semi-persistent CSI-RS resource activation indication, a CSI-RS resource indication, a delta of port number, and/or a dropping indication.

In some embodiments, a delta of port number indicates the change of the active port number. For example, current the active port number is A, delta of port number is B, then the indicated port number is function (A,B), function may be add or subtract. In this embodiments, a high layer signaling may configure one or more delta of port number, and first signaling is used to indicate one of delta of port number.

In some embodiments, a CSI-RS configuration indication associate with a port number means the CSI-RS configuration implicit or explicit indicates a port number or a CSI-RS configured with a port number.

In some embodiments, a dropping indication indicates UE to drop the CSI report which does not transmitted. In some embodiments, a dropping indication indicates UE to drop the CSI report which does not transmitted and perform CSI measurement based on current valid CSI-RS. The reason for the dropping indication is that the gNB antenna may changed and may affect the CSI measurement performed by UE. The CSI report generates before the gNB antenna changes is not correct and should be dropped.

In some embodiments, the CSI measurement configuration (e.g., CSI-MeasConfig) is used to configure a CSI-RS belonging to the serving cell in which CSI-MeasConfig is included, channel state information reporting to be transmitted on PUCCH on the serving cell in which CSI-MeasConfig is included, and channel state information reporting on PUSCH triggered by DCI received on the serving cell in which CSI-MeasConfig is included.

In some embodiments, the CSI measurement configuration indication indicates one or more CSI measurement configurations or one or more CSI measurement configuration IDs.

In some embodiments, the maximum port number indication indicates the maximum number of ports used for the UE. In some embodiments, the maximum port number indication may be indicated by an index. The maximum number of port used for the UE means the UE performs a measurement and/or a CSI report according to the CSI-RS configuration configured with a port number which is less than or equal to the maximum port number. For example, the maximum port number indication indicates 8 ports. The UE may only measure and report CSI according to the CSI-RS configuration with a port number less than or equal to 8 ports. In other words, the CSI-RS configurations which are configured with a port number greater than the indicated maximum port number are disabled/invalid.

In some embodiments, the port number list indication indicates the one or more port numbers supported by the UE. The port number list used for the UE means the UE performs measurement and/or CSI report according to CSI-RS configuration configured with a port number which is same as the indicated one or more port number. In other words, the CSI-RS configurations which are configured with a port number other than the indicated one or more port number are disabled/invalid.

For example, the port number list is {1, 2, 4, 8}, then the CSI-RS configuration which is configured with port 1, 2, 4, or 8 are enabled/valid, the CSI-RS configuration which is configured with port 12, 16, 24, or 32 are disabled/invalid.

In some embodiments, the maximum port indication indicates the maximum port used for UE. CSI-RS may be transmitted via antenna port 3000, 3001, . . . , 3031. The maximum port used for the UE means the UE performs measurement and/or CSI report according to CSI-RS transmitted via antenna port less than or equal to the indicated maximum port.

In some embodiments, the port indication indicates the port used for the UE. The port used for the UE means the UE performs measurement and/or CSI report according to a CSI-RS transmitted via an antenna port the same as the indicated port.

In some embodiments, the CSI-RS indication activates a CSI-RS configuration for the UE. The UE can measure a CSI based on the activated CSI-RS configuration.

In some embodiments, the base station state indication indicates a base station energy saving information. For example, a base station has multiple energy saving states, each energy saving state may be associated with a port number. If a base station state is indicated, the CSI-RS configurations configured with corresponding port numbers are valid/activated. In another example, if a base station state is indicated, the CSI-RS configurations configured with a port number not larger than the corresponding port number are valid/activated.

In some embodiments, the aperiodic CSI-RS resource activation indication triggers an aperiodic CSI-RS measurement and report. In some embodiments, it can implicitly indicate a port number. For example, if the UE receives a DCI triggering an aperiodic CSI-RS resource, each triggered aperiodic CSI-RS resource is associate with a port number, then the CSI-RS configuration or CSI report configured with the same port number are activated/used. For another example, if the UE receives a DCI triggering an aperiodic CSI-RS resource, then the CSI-RS resource or CSI report configured with a port number smaller than or equal to the port number which is triggered are activated/used.

In some embodiments, the semi-persistent CSI-RS resource activation indication may activate a semi-persistent CSI-RS resource. It may also implicitly indicate a port number. For example, if the UE receives a first signaling (e.g., a MAC CE) activating a semi-persistent CSI-RS resource, the CSI-RS configuration configured with the port number same as the port number of the activated CSI-RS may also be valid/activated. In another example, if the UE receives a first signaling (e.g., a MAC CE) activating a semi-persistent CSI-RS resource, the CSI-RS configuration configured with a smaller or a same port number may also be valid/activated.

In some embodiments, if UE receives a first signaling (e.g., a MAC CE) activating a semi-persistent CSI-RS resource, each semi-persistent CSI-RS resource is associate with a port number, the CSI-RS configuration configured with the same or a smaller port number which is semi-persistent CSI-RS may also be valid/activated.

In some embodiments, the first signaling is a DCI (downlink control information).

In some embodiments, the DCI is a group common DCI. Group common DCI means the DCI carries information for one or more UEs. A field in the DCI is used to indicate information for one or more UEs.

In some embodiments, a field of X bits in the group common DCI is used to indicate CSI-RS configuration information for one or more UEs. The CSI-RS configuration information may be indicated by a bitmap or a codepoint.

In some embodiments, the CSI-RS configuration information is a port number activation/de-activation indication. The port number activation/de-activation is indicated by a bitmap. For example, each bit in the field indicates one port number activation/de-activation. ‘O’ means the port number is de-activated, ‘1’ means the port number is activated. The bit and port number mapping may be configured by a high layer signaling. (e.g., 3 bits corresponding to port number 2, 4, 8 respectively. ‘011’ means port number 2, 4 are valid and port number 8 are invalid.) In some embodiments, a port number is activated or de-activated means the CSI-RS configuration associate with the port number is activated or de-activated. In some embodiments, a port number is activated or de-activated means the CSI report configuration associate with the port number is activated or de-activated.

In some embodiments, the CSI-RS configuration information is a port number list indication information. The port number list indication information is indicated by a codepoint.

In some embodiments, the bitwidth of the field is determined based on a high layer signaling.

For one example, the bitwidth of the field is explicitly configured by a high layer signaling.

For another example, the bitwidth of the field is derived according to a high layer signaling. The bitwidth is determined according to the number of kind of CSI-RS port number (K) the UE configured. In some embodiments, the bitwidth is a function (log₂(K)), function is round up or round down or round. For example, a UE is configured with 4 kinds of CSI-RS port numbers (1 port, 2 port, 8 port, 16 port), then the bitwidth is function (log₂(4)), function is round up or round down or round. In some embodiments, the bitwidth is same as the number of kind of CSI-RS port number UE configured. Each bit indicates one activation/de-activation information of the corresponding kind of CSI-RS port. For example, a UE is configured with 4 kinds of CSI-RS port numbers (1 port, 2 port, 8 port, 16 port), then the bitwidth is 4, the first bit indicates the activation/de-activation information of CSI-RS configured with 1 port, and so on.

For another example, the bitwidth of the field is derived according to a high layer signaling. The bitwidth is determined according to the maximum port number of CSI-RS UE configured.

For another example, the bitwidth of the field is derived according to a high layer signaling. The bitwidth is determined according to the items (entries) configured in a port number list. In some embodiments, the bitwidth is a function (log₂(K)), function is round up or round down or round. K is the number of the items (entries). For example, a port number list is configured as {{8}, {16}, {4}, {2}}, then the bitwidth is function (log₂(4)).

For another example, the bitwidth of the field is derived according to a UE capability. The UE capability may indicate at least one of the following: the maximum number of CSI-RS port the UE supported, the kind of port number the UE supported, the maximum kind of port number the UE supported, the number of items a port number list can be configured, the bitwidth the UE supported.

In some embodiments, the bitwidth is predefined.

In some embodiments, the position of the field for a UE in the group common DCI is configured by a high layer signaling.

In some embodiments, the DCI is a dedicated DCI. Dedicated DCI means the DCI carries information for one UE.

A field in the dedicated DCI is used to indicate the information.

In some embodiments, the bitwidth of the field in the dedicate DCI can be determined similar to the embodiments above, and details in this regard will not be described herein.

The dedicated DCI may be a scheduling DCI or non-scheduling DCI. Scheduling DCI is a DCI including DL assignment or UL grant. Non scheduling DCI is a DCI not including scheduling information.

In some embodiments, the dedicated DCI includes a field indicating triggering/activation of CSI Reports or CSI-RS, the field implicitly indicating a port number, the port number being the port number configured for the CSI-RS.

In some embodiments, the DCI is a broadcast or multicast DCI.

The broadcast or multicast DCI is scrambled with at least one of the following RNTI: MCCH-RNTI (Multicast broadcast services control channel RNTI), G-RNTI (Group RNTI), G-CS-RNTI (Group configured scheduling RNTI).

A field in the broadcast or multicast DCI is used to indicate the CSI-RS configuration information.

In some embodiments, the bitwidth of the field in the broadcast or multicast DCI can be determined similar to the embodiments above, and details in this regard will not be described herein.

In some embodiments, the DCI is scrambled with a specific RNTI. For example, the specific RNTI is only used for the CSI-RS configuration indication.

In some embodiments, the DCI is scrambled with at least one of the following RNTI: MCCH-RNTI, G-RNTI, G-CS-RNTI.

In some embodiments, the DCI is a specific DCI. For example, the specific DCI is only used for CSI-RS configuration indication.

In some embodiments, the CSI-RS configuration indication indicated by a DCI can only be used to at least a semi-persistent CSI-RS resource or an aperiodic CSI-RS resource.

In some embodiments, the first signaling is a MAC CE.

In some embodiments, the MAC CE is scheduled by a broadcast/multicast DCI.

Each field in the MAC CE indicates an activation/de-activation indication for a port number.

In some embodiments, the MAC CE is a semi-persistent CSI-RS/CSI-IM Resource Set Activation/Deactivation MAC CE.

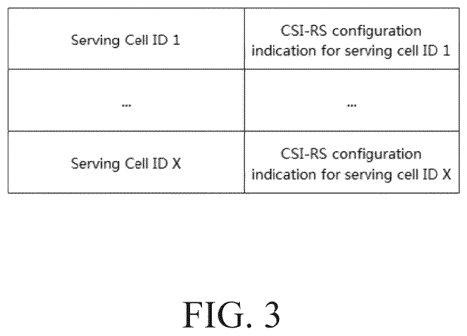

In some embodiments, the MAC CE indicates CSI-RS configuration indication for multiple cells. For example, the MAC CE indicates a serving cell ID first, and followed by the CSI-RS configuration indication for the serving cell (see FIG. 3).

In some embodiments, the CSI-RS configuration indication indicated by the MAC CE may be CSI-RS resource set activation/de-activation indication.

In another example, the MAC CE indicates a serving cell ID first, and followed by port number activation/de-activation indication for each port number in the serving cell.

In some embodiments, the MAC CE includes at least one of the following:
the CSI-RS configuration indication (e.g., port number list, or maximum port number),
a field indicating whether to activate or deactivate indicated the port number, for example, the field is set to 1 to indicate activation, otherwise it indicates deactivation;
a serving cell ID, this field indicates the identity of the Serving Cell for which the MAC CE applies;
a BWP ID, this field indicates a DL BWP for which the MAC CE applies; and/or
a port number list ID, indicating the port number list, which shall be activated or deactivated.

In some embodiments, the first signaling is a SIB (system information block).

In some embodiments, a first signaling is a DCI and a MAC CE. DCI is used to indicate CSI-RS configuration indication for semi-persistent CSI-RS configuration or aperiodic CSI-RS configuration. And MAC CE is used to indicate CSI-RS configuration indication for semi-persistent CSI-RS configuration or periodic CSI-RS configuration.

### Aspect 5A: UE Behavior

In some embodiments, the UE may perform, measure and/or transmit the CSI report according to the RRC signaling and/or the first signaling.

In some embodiments, UE is configured a CSI-RS configuration or CSI report configuration associated with a port number list. In some embodiments, if the UE does not receive a first signaling indicating a CSI-RS configuration information (e.g., a port number indication), the UE performs measurements and/or CSI report according to all the activated CSI-RS configuration. In some embodiments, if the UE does not receive a first signaling indicating a CSI-RS configuration information (e.g., a port number indication), the UE performs measurements and/or CSI report according to the activated CSI-RS configuration using the maximum port number if more than one port numbers are configured in the CSI-RS configuration.

In some embodiments, the TCI states of a semi-persistent CSI-RS or aperiofic CSI-RS is indicated by the first signaling.

In some embodiments, an offset of a semi-persistent CSI-RS or aperiofic CSI-RS is indicated by the first signaling.

In some embodiments, the offset is indicated in time domain resource assignment field.

In some embodiments, if the UE receives a first signaling indicating a CSI-RS configuration information, the indicated CSI-RS configuration information is applied/valid/activated at least after a time delay (also referred to as time period in this disclosure).

In some embodiments, if the UE receives a first signaling indicating a CSI-RS configuration information, the UE performs CSI-RS measurement according to the indicated CSI-RS configuration information at least after a first time delay (also referred to as first time period in this disclosure).

In some embodiments, if the UE receives a first signaling indicating a CSI-RS configuration information, the UE reports CSI according to the indicated CSI-RS configuration information at least after a second time delay (also referred to as second time period in this disclosure). In some embodiments, if the UE receives a first signaling indicating a CSI-RS configuration information, the UE reports CSI according to the indicated CSI-RS configuration information at least after a second time delay after receiving a valid CSI-RS. In some embodiments, UE transmits CSI report at least after a valid CSI-RS configuration resource if the UE receives a first signaling indicating a CSI-RS configuration information.

In some embodiments, the first time delay may be less than or equal to the second time delay.

In some embodiments, the time delay/first time delay/second time delay may be associated with at least one of the following: a predefined value, a time domain behavior, a UE capability, an SFN (system frame number), a FR (frequency range) type, a SCS, a ACK, PUSCH processing time, a CSI computation time, a PDSCH processing time, a BWP switching delay, a high layer signaling. In some embodiments, the time delays described in this disclosure indicate time periods.

In some embodiments, the time delay/first time delay/second time delay is configured by a high layer signaling.

In some embodiments, the time delay/first time delay/second time delay is associated with at least a UE capability and a predefined value. For example, different UE capability may associate with different predefined value.

In some embodiments, the time delay/first time delay/second time delay is associated with at least an SFN. For example, the activated CSI-RS configuration or CSI report configuration are valid from the first slot in an SFN after the SFN in which UE receives the first signaling.

In some embodiments, the time delay/first time delay/second time delay is associated with at least a ACK. For example, the activated CSI-RS configuration or CSI report configuration are valid after UE transmit an ACK for the first signaling. In another example, the activated CSI-RS configuration or CSI report configuration are valid after N symbols/slot/milliseconds/sub-frame after UE transmit an ACK for the first signaling.

In some embodiments, the time delay/first time delay/second time delay is associated with at least a BWP switching delay. For example, the activated CSI-RS configuration or CSI report configuration are valid after a BWP switching delay.

In some embodiments, the time delay/first time delay/second time delay is associated with at least a FR type. For example, the time delay/first time delay/second time delay for FR 1 is less than the time delay/first time delay/second time delay for FR 2.

In some embodiments, the time delay/first time delay/second time delay is associated with at least a PUSCH processing time. For example, the time delay/first time delay/second time delay is larger than or equal to the PUSCH processing time.

In some embodiments, the time delay/first time delay/second time delay is associated with at least a CSI computation time. For example, the time delay/first time delay/second time delay is larger than or equal to the CSI computation time.

In some embodiments, the time delay/first time delay/second time delay is associated with at least a PDSCH processing time. For example, the time delay/first time delay/second time delay is larger than or equal to the PDSCH processing time.

In some embodiments, the time delay/first time delay/second time delay is different for different time domain behavior CSI-RS resource. The time domain behavior includes ‘aperiodic’, ‘semi-persistent’, ‘periodic’. For example, the first time delay for ‘aperiodic’ CSI-RS resource is greater than the first time delay for ‘semi-persistent’ CSI-RS resource, and the first time delay for ‘semi-persistent’ CSI-RS resource is greater than the first time delay for ‘periodic’ CSI-RS resource.

In some embodiments, the time delay/first time delay/second time delay is different for different time domain behavior CSI report.

In some embodiments, the time delay/first time delay/second time delay is a predefined value. The predefined value may be N symbols/slots/sub-frame/millisecond.

In some embodiments, the predefined value is N symbols/slots, the SCS of the predefined value is based on at least one of the following:
the smallest SCS among all active BWP,
the smaller SCS between a DL BWP in which the first signaling is received and the UL BWP in which a CSI report is transmitted,
the smallest SCS among a DL BWP in which the first signaling is received, a DL BWP in which the indicated CSI-RS resource is configured, and the UL BWP in which a CSI report is transmitted,
a predefined SCS,
the SCS of a DL BWP in which the first signaling is received,
the SCS of a DL BWP in which the indicated CSI-RS resource is configured or a CSI-RS is received,
the SCS of the UL BWP in which a CSI report is transmitted,
the SCS of a scheduling cell, and/or
the SCS of a scheduled cell.

In some embodiments, if the UE receives a first signaling indicating a CSI-RS configuration information indication, during the time delay/first time delay/second time delay, the UE does not measure on CSI-RS which will be not activated after the time delay/first time delay/second time delay according to the CSI-RS configuration information indication.

In some embodiments, if the UE receives a first signaling indicating a CSI-RS configuration information indication, during the time delay/first time delay/second time delay, the UE will not report CSI if the CSI is determined based on a CSI-RS which will be not activated after the time delay/first time delay/second time delay according to the CSI-RS configuration information indication.

In some embodiments, if the UE receives a first signaling indicating a dropping indication, UE will drop the CSI report which is generated before the first signaling or UE will not transmit the CSI report which is generated before the first signaling.

In some embodiments, if the UE receives a first signaling indicating a CSI-RS configuration information, the activated/valid CSI-RS configuration may be activated at a different time for different time domain behavior. For aperiodic CSI-RS configuration included in the activated CSI-RS resource, the aperiodic CSI-RS resource is activated starting after a time delay and ending at the end of the scheduled PUSCH containing the report associated with the aperiodic CSI-RS. For semi-persistent CSI-RS configuration or periodic CSI-RS configuration included in the activated CSI-RS resource, the semi-persistent CSI-RS configuration or periodic CSI-RS configuration is activated starting after a time delay and ending at the slot in which a deactivation indication is applied.

In some embodiments, the UE receives a first signaling indicating a CSI-RS configuration information, and the CSI-RS configuration information is a port number list indication, or a port number activation/de-activation indication, or a port number indication. If the indicated CSI-RS configuration information includes a port number for which UE is not configured, the UE ignores the corresponding indication.

For one example, the UE is configured a CSI-RS configuration with port number {0, 2}, if the UE receives a first signaling indicating activating port number {8}, then the UE ignores the indication.

For another example, the UE is configured a CSI-RS configuration with port number {0, 2}, if the UE receives a first signaling indicating activating group port number {8}, then the UE de-activates the port number {0,2}.

In some embodiments, the UE receives a first signaling indicating a CSI-RS configuration information, and the CSI-RS configuration information is a port number list indication, or a port number activation/de-activation indication, or a port number indication. If the indicated CSI-RS configuration information includes a port number for which UE is not configured, the UE uses a baseline CSI-RS configuration.

In some embodiments, the baseline CSI-RS configuration is a CSI-RS configuration configured with a predefined port number or the CSI-RS configuration configured with only one port number or CSI-RS configuration using the maximum port number if more than one port number is configured or a predefined CSI-RS configuration. In some embodiments, the predefined port number or the predefined CSI-RS configuration is configured by a high layer signaling.

In some embodiments, the UE receives a first signaling which indicates a CSI-RS configuration indication. The CSI-RS configuration indication may only be valid for a CSI-RS resource or a CSI-RS configuration with second kind time domain behavior. For example, the second kind time domain behavior may be semi-persistent or periodic. For another example, the second kind time domain behavior includes at least aperiodic.

In some embodiments, the UE receives a first signaling which indicates a CSI-RS configuration indication. The CSI-RS configuration indication may only be valid for a CSI-RS resource or a CSI-RS configuration with second kind usage. The usage includes Channel Measurement (CSI report configuration configured with resourcesForChannelMeasurement), interference measurement (CSI report configuration configured with CSI-IM-ResourcesForInterference), rate matching (configured with ZP-CSI-RS-Resource) or intra cell interference measurement (CSI report configuration configured with nzp-CSI-RS-ResourcesForInterference). For example, the second kind usage includes at least channel measurement. For another example, the second kind usage includes at least one of the following: channel measurement and intra cell interference measurement, and rate matching.

In some embodiments, the UE receives a first signaling which indicates a CSI-RS configuration indication. The CSI-RS configuration indication may only be valid for a CSI report configuration configured with second kind time domain behavior. The time domain behavior for a CSI report configuration includes ‘aperiodic’, ‘semiPersistentOnPUCCH’, ‘semiPersistentOnPUSCH’, or ‘periodic’. For example, the second kind time domain behavior includes at least ‘aperiodic’.

In some embodiments, the CSI-RS configuration and the corresponding CSI measurement report configuration are activated correspondingly. In some embodiments, the CSI-RS configuration and the corresponding CSI measurement report configuration are activated together. For example, if a CSI-RS configuration is activated by a first signaling, the corresponding CSI measurement report configuration is implicit activated. As another example, if a CSI measurement report configuration is activated by a first signaling, the corresponding CSI-RS configuration is implicit activated.

### Aspect 5B: UE Capability

In some embodiments, the UE reports the UE capability to the gNB. The UE capacity may include at least one of the following: whether or not port number list indication is supported, whether or not configuring more than one port number in a CSI-RS resource is supported, whether or not configuring different port number in a CSI-RS resource set used for channel measurement is supported, the support maximum number of port number, whether or not support a CSI-RS configuration indication by DCI, whether or not support a CSI-RS configuration indication by MAC CE, whether or not terminal support a CSI-RS configuration indication, types of port that can be reported at the same time or same slot.

In some embodiments, UE capability is transmitted by MAC CE or BSR (buffer status report) or CSI report or SRS (sounding reference signal) or RRC signaling.

### Aspect 6: UE Assistance Information

In some embodiments, the UE reports UE assistance information to the gNB. The UE assistance information may include at least one of the following: preferred port number, preferred port number list, preferred maximum port number, preferred to fallback to a baseline CSI-RS, preferred to switch to a power saving state, preferred TCI (Transmission Configuration Indicator) state, a preferred beam indication.

In some embodiments, the UE assistance information is transmitted via UCI, PUSCH, or a UL MAC CE signaling. In some embodiments, the UE assistance information is transmitted by MAC CE or BSR (buffer status report) or CSI report or SRS (sounding reference signal) or RRC signaling.

In some embodiments, the UE transmits the UE assistance information after at least one of the following events occur: a beam failure, transmission of a preamble, a RACH procedure, receiving a CSI-RS configuration indication, a BWP switching.

### Aspect 7: Enablement

In some embodiments, the first signaling indication is enabled if an event occurs. In some embodiments, the first signaling indication is enabled means that the gNB can transmit first signaling to UE. In some embodiments, the first signaling indication is enabled means the UE will monitor the first signaling. In some embodiments, the first signaling indication is enabled means the gNB can transmit first signaling with the CSI-RS configuration indication to UE. In some embodiments, the first signaling indication is enabled means the field is existing.

In some embodiments, the event includes at least one of the events below.

A RRC signaling is configured to enable the first signaling indicates the CSI-RS configuration.

A CSI-RS resource associated with more than one port number is configured

A CSI-RS resource set used for channel measurement includes CSI-RS with different port number.

A RRC signaling which enables the more than one port number configured for a CSI-RS resource is enabled or configured.

A RRC signaling which enables the more than one port number configured within a CSI-RS resource set for a channel measurement is enabled or configured.

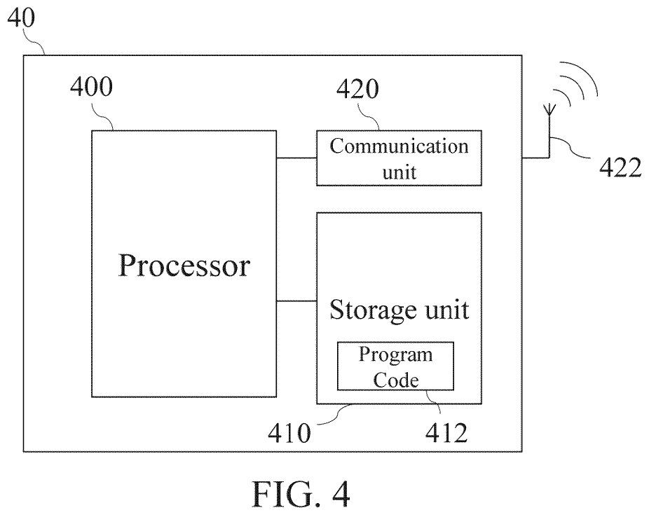

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 412 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g., messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g., a base station).

In some embodiment, the wireless terminal 40 may be used to perform the operations of the UE described above. In some embodiments, the processor 400 and the communication unit 420 collaboratively perform the operations described above. For example, the processor 400 performs operations and transmit or receive signals through the communication unit 420.

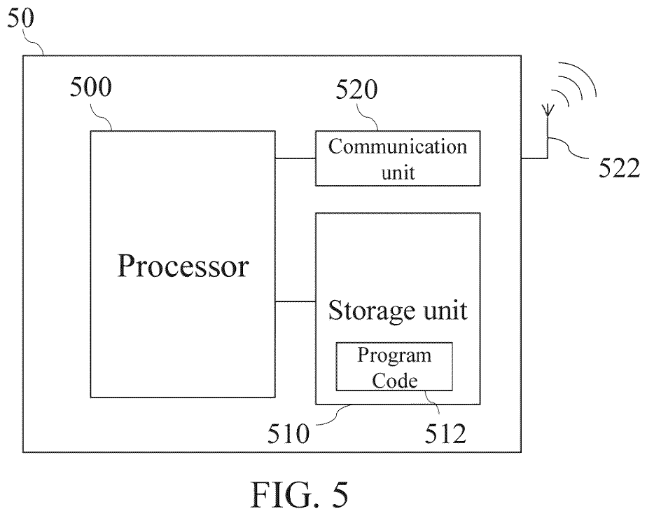

FIG. 5 relates to a schematic diagram of a wireless network node 50 according to an embodiment of the present disclosure. The wireless network node 50 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user place function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 512 include but are not limited to a SIM, ROM, flash memory, RAM, hard-disk, and optical data storage device. The communication unit 520 may be a transceiver and is used to transmit and receive signals (e.g. messages or packets) according to processing results of the processor 500. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g. a user equipment or another wireless network node).

In some embodiment, the wireless network node 50 may be used to perform the operations of the gNB or base station described above. In some embodiments, the processor 500 and the communication unit 520 collaboratively perform the operations described above. For example, the processor 500 performs operations and transmit or receive signals through the communication unit 520.

In accordance with some embodiments of the present disclosure, a wireless communication method includes: receiving, by a wireless communication terminal (e.g., the UE described above) from a wireless communication node (e.g., the gNB or base station described above), control signaling comprising channel state information reference signal, CSI-RS, configuration information; receiving, by the wireless communication terminal from the wireless communication node, first signaling comprising a CSI-RS configuration indication associated with a port number (e.g., the port number or the number of ports described above) or a dropping indication; and performing, by the wireless communication terminal, at least one of a CSI-RS measurement or a transmission of a channel state information, CSI, measurement report to the wireless communication node based on at least one of the CSI-RS configuration information or the CSI-RS configuration indication in the first signaling.

In accordance with some embodiments of the present disclosure, a wireless communication method includes: transmitting, by a wireless communication node to a wireless communication terminal, control signaling comprising channel state information reference signal, CSI-RS, configuration information; transmitting, by the wireless communication node to the wireless communication terminal, first signaling comprising a CSI-RS configuration indication associated with a port number or a dropping indication; and receiving, by the wireless communication node from the wireless communication terminal, a channel state information, CSI, measurement report to the wireless communication node based on at least one of the CSI-RS configuration information or the CSI-RS configuration indication in the first signaling.

In an embodiment, the control signaling may be the high layer signaling described above which includes at least one of the CSI-RS configuration information, the CSI report configuration, and/or the port number list described above.

In an embodiment, the association between the CSI-RS configuration information and port numbers may include the associations between the configurations in the CSI-RS configuration information and the port numbers described above.

In an embodiment, the association between the CSI measurement report configurations and the port numbers may include the associations between the CSI measurement report configurations and the port numbers specified in the embodiments above.

In an embodiment, the CSI-RS configuration indication can include the indications or information in the first signaling described above.

Details of the wireless communication methods can be ascertained by referring to the embodiments above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

I/We claim:

1. A wireless communication method comprising:
receiving, by a wireless communication terminal from a wireless communication node, control signaling comprising channel state information reference signal, CSI-RS, configuration information;
receiving, by the wireless communication terminal from the wireless communication node, first signaling comprising a CSI-RS configuration indication associated with a port number or a dropping indication; and
performing, by the wireless communication terminal, at least one of a CSI-RS measurement or a transmission of a channel state information, CSI, measurement report to the wireless communication node based on at least one of the CSI-RS configuration information or the CSI-RS configuration indication in the first signaling.

2. The wireless communication method of claim 1, wherein the control signaling comprises at least one of Radio Resource Control, RRC, signaling or Medium Access Control Control Element, MAC CE, signaling; and/or
the control signaling comprises at least one of: the CSI-RS configuration information, a CSI measurement report configuration, one or more CSI measurement configurations, or a port number list comprising one or more port numbers or one or more port number sets.

3. The wireless communication method of claim 2, wherein the one or more port numbers or one or more port number sets are associated with at least one: the CSI-RS configuration information, the CSI measurement report configuration, a code book configuration, a power control offset adjust value from a maximum port number, or a CSI-RS resource mapping.

4. The wireless communication method of claim 2, wherein
a CSI-RS resource mapping comprises at least one of: a time domain resource, a frequency domain resource, a CDM group, or a power control offset for a predefined port number, and wherein at least one of: a time domain resource, a frequency domain resource, a CDM group, or a power control offset for a first port number is determined according to the at least one of: the time domain resource, the frequency domain resource, the CDM group, or the power control offset for the predefined port number; and/or
wherein the predefined port number is a maximum port number in the port number list or a port number set configured in the CSI-RS resource mapping, or the port number configured in the CSI-RS resource mapping.

5. The wireless communication method claim 4, wherein the predefined port number is a maximum port number, a time domain resource, a frequency domain resource, a CDM group, or a power control offset for a first port number is determined according to the at least one of: the time domain resource, the frequency domain resource, the CDM group, or the power control offset for the maximum port number, wherein:
the time domain resource and frequency domain resource for the first port number is M items of the time domain resource and frequency domain resource for the maximum port number; or
the time domain resource and frequency domain resource for the first port number is the time domain resource and frequency domain resource of the M CDM groups for the maximum port number; or
the CDM group for the first port number is the first M CDM groups for the maximum port number;
and wherein, M is equal to a value of the first port number divided by a CDM type number.

6. The wireless communication method of claim 1, wherein the CSI-RS configuration information comprises a CSI-RS resource set, and the CSI-RS resource set comprises one or more CSI-RS resources configured with different port numbers; and/or
the CSI-RS resources set is for at least one of: a channel measurement, an interference measurement; and/or
a CSI-RS resource comprises at least one of a time domain resource, a frequency domain resource, a CDM type, a density, a CDM group, or a power control offset; and/or
the CSI-RS resources have a hierarchical relationship therebetween.

7. The wireless communication method of claim 6, wherein at least one of a first time and frequency domain resource, a first CDM group, or a first density for a first one of the CSI-RS resource corresponding to a first port number is a subset of at least one of a second time and frequency domain resource, a second CDM group, or a second density for a second one of the CSI-RS resource corresponding to a second port number within the CSI-RS resource set, and the first port number is less than the second port number; and/or
a first time and frequency domain resource for one of the CSI-RS resource corresponding to a maximum port number is a union set of time and frequency domain resources for all the CSI-RS resource within the CSI-RS resource set; and/or
a power control offset for a first one of the CSI-RS resource corresponding to a first port number is less than a power control offset for a second one of the CSI-RS resource corresponding to a second port number within the CSI-RS resource set, and the first port number is less than the second port number.

8. The wireless communication method of claim 7, wherein the wireless communication terminal configures the CSI-RS configuration information separately for different port numbers, the CSI-RS resource configured in the CSI-RS configuration information are configured with a same port number, wherein the CSI-RS configuration information is a CSI-RS resource setting or a CSI resource configuration.

9. The wireless communication method of claim 1, wherein if a CSI-RS resource mapping is associate with a port number list configured with more than one port numbers or a port number set configured with more than one port numbers, the wireless communication terminal performs a CSI-RS measurement according to each valid port number in the port number list or the port number set.

10. The wireless communication method of claim 1, wherein
the CSI-RS configuration indication comprises at least one of: a maximum port number indication, a port number activation or de-activation indication, a maximum port indication, a port number indication, a port number set indication, a base station state indication, an aperiodic CSI-RS resource activation indication, an aperiodic CSI measurement report activation indication, a CSI measurement configuration indication, a semi-persistent CSI-RS resource activation indication, a dropping indication, or a CSI-RS resource indication; and/or
the first signaling comprises at least one of: common downlink control information, DCI, dedicate DCI, broadcast DCI, multicast DCI, an MAC CE, or a system information block, SIB; and/or
the first signaling comprises an indicating field for one or more user equipments, UEs.

11. The wireless communication method of claim 10, wherein the CSI-RS configuration indication in the common DCI, the dedicate DCI, the broadcast DCI, or the multicast DCI is for at least one of a semi-persistent CSI-RS resource or an aperiodic CSI-RS resource.

12. The wireless communication method of claim 10, wherein
the dedicate DCI comprises a field indicating a triggering or an activation of the CSI measurement report or a CSI-RS resource, and a port number for the CSI-RS resource corresponding to the CSI measurement report or a port number for the CSI-RS resource is implicitly indicated by the field; and/or
the MAC CE comprises at least one of: the CSI-RS configuration indication, a field indicating an activation or deactivation of a port number or a port number set, a serving cell identifier, ID, a bandwidth part, BWP, ID, or a port number list ID.

13. The wireless communication method of claim 1, wherein the wireless communication terminal performs at least one of the following operations:
applying, validating or activating the CSI-RS configuration information after a time period relative to the reception of the first signaling;
dropping, the CSI report which is generated before the first signaling;
performing the CSI-RS measurement after a first time period relative to the reception of the first signaling;
performing the transmission of the CSI measurement report after a second time period relative to the reception of a valid CSI-RS; or
performing the transmission of the CSI measurement report after a second time period relative to the reception of the first signaling or a valid CSI-RS configuration.

14. The wireless communication method of claim 13, wherein:
at least one of the time period, the first time period, or the second time period is associated with at least one of: a predefined value, a time domain behavior, a UE capability, a system frame number, SFN, a Subcarrier Spacing, SCS, an acknowledgement, ACK, a physical uplink shared channel, PUSCH, preparation processing time, a CSI computation time, a frequency range, FR, type, a bandwidth part, BWP, switching delay, a high layer signaling, or a physical downlink shared channel, PDSCH, processing time; and/or
at least one of the time period, the first time period, or the second time period is predetermined or associated with a time domain behavior of a CSI-RS resource or a time domain behavior of the CSI measurement report;
wherein
during at least one of the time period, the first time period, or the second time period, the wireless communication terminal does not perform a CSI-RS measurement for a CSI-RS configuration not applied, validated, or activated after the time period; and/or
during at least one of the time period, the first time period, or the second time period, the wireless communication terminal does not transmit a CSI measurement report based on a CSI-RS configuration not activated after the time period or a CSI measurement report configuration not activated after the time period.

15. The wireless communication method of claim 1, wherein when the CSI-RS configuration indication indicates a port number that the wireless communication terminal is not configured with, the wireless communication terminal ignores the CSI-RS configuration indication or perform the transmission of the CSI measurement report based on a baseline CSI-RS configuration.

16. The wireless communication method of claim 1, wherein
the CSI-RS configuration indication is valid when the CSI-RS configuration indication is for at least one of an aperiodic CSI measurement report activation indication, a semi-persistent CSI-RS resource activation indication, or a periodic CSI-RS resource indication; and/or
the CSI-RS configuration indication is valid when the CSI-RS configuration indication is for a CSI-RS resource for at least one of: channel measurement, interference measurement, rate matching, or intra cell interference measurement; and/or
the CSI-RS configuration indication is valid when the CSI-RS configuration indication is for at least one of: an aperiodic CSI measurement report, a semi-persistent CSI measurement report, or a periodic CSI measurement report.

17. The wireless communication method of claim 1, wherein:
the wireless communication terminal transmits at least one of the following to the wireless communication node: whether the wireless communication terminal supports a port number list indication, whether the wireless communication terminal supports to be configured with more than one port numbers in a CSI-RS resource, whether the wireless communication terminal supports a CSI-RS configuration indication by DCI, whether the wireless communication terminal supports a CSI-RS configuration indication by a MAC CE, whether the wireless communication terminal supports a CSI-RS configuration indication, whether the wireless communication terminal supports to be configured with different port numbers in a CSI-RS resource set used for a channel measurement, a maximum support number of a port number, or a number of ports number types able to be reported at the same time or same slot; and/or
the wireless communication terminal transmits at least one of the following to the wireless communication node: a preferred port number, a preferred port number list, a preferred maximum port number, a preference of falling back to a baseline CSI-RS configuration, a preference of switching to a power saving state, a preference of Transmission Configuration Indicator, TCI, state, a preference of beam indication.

18. The wireless communication method of claim 1, wherein the first signaling is enabled when at least one of the following events occurs:
Radio Resource Control, RRC, signaling is configured to enable the first signaling indicates the CSI-RS configuration;
a CSI-RS resource associated with more than one port numbers is configured;
a CSI-RS resource set used for a channel measurement including a CSI-RS with different port numbers;
RRC signaling enabling more than one port number configured for a CSI-RS resource is enabled; or
RRC signaling enabling more than one port number configured within a CSI-RS resource set for a channel measurement is enabled; and/or
wherein the first signaling is enabled comprises at least one of: the wireless communication node is able to transmit the first signaling to the wireless communication terminal; the wireless communication node is able to transmit the first signaling with CSI-RS configuration indication to the wireless communication terminal; the wireless communication terminal monitors the first signaling; or an indicating field indicating an activation or deactivation of one or more port numbers exists in the first signaling.

19. The wireless communication method of claim 1, wherein performing the CSI-RS measurement or a transmission of the CSI measurement report to the wireless communication node comprises at least one of the following:
the wireless communication terminal does not measure CSI based on a de-activated CSI-RS configuration;
the wireless communication terminal does not transmit the CSI measurement report if the CSI measurement report is not associated with a valid or active CSI-RS configuration;
the wireless communication terminal does not expect to receive signaling to trigger a trigger state which is associated with an invalid or de-activated CSI-RS configuration; or
the wireless communication terminal does not expect to receive signaling to trigger a trigger state which is associated with an invalid or de-activated CSI measurement report configuration;
wherein, the valid, active, invalid, or de-activated CSI-RS configuration or CSI measurement report configuration is determined based on at least one of the CSI-RS configuration information or the CSI-RS configuration indication in the first signaling.

20. A wireless communication terminal, comprising:
a transceiver; and
at least one processor,
wherein the transceiver is configured to receive, from a wireless communication node, control signaling comprising channel state information reference signal, CSI-RS, configuration information; receive, from the wireless communication node, first signaling comprising a CSI-RS configuration indication associated with a port number or a dropping indication; and
the at least on processor is configured to perform at least one of a CSI-RS measurement or a transmission of a channel state information, CSI, measurement report to the wireless communication node based on at least one of the CSI-RS configuration information or the CSI-RS configuration indication in the first signaling.
